(19) United States
(12) Patent Application Publication
(10) Pub. No.: US 2005/0259729 A1
(43) Pub. Date: Nov. 24, 2005

(54) Video coding with quality scalability

(76) Inventor: Shijun Sun, Vancouver, WA (US)

Correspondence Address: DAVID C RIPMA, PATENT COUNSEL;SHARP LABORATORIES OF AMERICA, 5750 NW PACIFIC RIM BLVD, CAMAS, WA, 98607, US

(21) Appl. No.: 11/060,891

(22) Filed: Feb. 18, 2005

Related U.S. Application Data
(60) Provisional application No. 60/573,071, filed on May 21, 2004.

(51) Int. Cl. H04N 7/12

(52) U.S. Cl. 375/240.1; 375/240.08; 375/240.25

(57) ABSTRACT

A method of coding a quality scalable video sequence is provided. An N-bit input frame is converted to an M-bit input frame, where M is an integer between 1 and N. To be backwards compatible with existing 8-bit video systems, M would be selected to be 8. The M-bit input frame would be encoded to produce a base-layer output bitstream. An M-bit output frame would be reconstructed from the base-layer output bitstream and converted to a N-bit output frame. The N-bit output frame would be compared to the N-bit input frame to derive an N-bit image residual that could be encoded to produce an enhancement layer bitstream.

### CROSS-REFERENCE TO RELATED CASES

The present application claims the benefit of U.S. Provisional Application No. 60/573,071, filed May 21, 2004, invented by Shijun Sun, and entitled “Professional Video Coding with Quality Scalability,” which is hereby incorporated herein by reference.

### BACKGROUND OF THE INVENTION

The present method relates to video encoding, and more particularly to video coding using enhancement layers to achieve quality scalability.

Many existing video coding systems are designed to handle 8-bit video sequences. These 8-bit video sequences may for example be used in 4:2:0, 4:2:2, or 4:4:4 YUV or RGB format. Methods have been proposed to support applications requiring higher bit-depths, such as 10-bit video data or 12 bit video data in 4:2:2 YUV or 4:4:4 RGB format, which may be useful in a variety of applications including professional video coding. A typical example of a professional video coding standard is the Fidelity Range Extension (FRExt) of H.264, which was completed in July 2004.

The existing 8-bit video systems are not capable of handling high bit-depth bitstreams, or bitstreams using new color formats. The existing methods of implementing professional video coding standards typically rely on specially designed coding algorithms and bitstream syntax.

### SUMMARY

Accordingly, a method of coding a quality scalable video sequence is provided. An N-bit input frame is converted to an M-bit input frame, where M is an integer between 1 and N. To be backwards compatible with existing 8-bit video systems, M would be selected to be 8. The M-bit input frame would be encoded to produce a base-layer output bitstream. An M-bit output frame would be reconstructed from the base-layer output bitstream and converted to a N-bit output frame. The N-bit output frame would be compared to the N-bit input frame to derive an N-bit image residual that could be encoded to produce an enhancement layer bitstream.

A method for decoding the quality scalable video sequence from a base layer bitstream and an enhancement layer bitstream is also provided.

Embodiments of the coding and decoding methods may be preformed in hardware or software using an encoder or a decoder to implement the described methods.

### BRIEF DESCRIPTION OF THE DRAWINGS

FIG. 1 illustrates an encoding process for a quality scalable video encoder.

FIG. 2 illustrates a decoding process for a quality scalable video encoder.

FIG. 3 illustrates an encoding process for a quality scalable video encoder.

FIG. 4 illustrates a decoding process for a quality scalable video encoder.

FIG. 5 illustrates an encoding process for a quality scalable video encoder.

FIG. 6 illustrates a decoding process for a quality scalable video encoder.

FIG. 7 illustrates an encoding process for a quality scalable video encoder.

### DETAILED DESCRIPTION OF THE INVENTION

Embodiments of quality-scalable coding methods are provided to enable higher bit depth or alternative color formats, such as those proposed for professional video coding, while providing backwards compatibility with existing 8-bit video sequences.

In an embodiment of a present coding method, a first layer, which may be referred to as a base-layer bitstream, contains data for an 8-bit video sequence. At least one additional layer, which may be referred to as an enhancement layer, contains data that will enable reconstruction of a video sequence in combination with the base-layer bitstream, but at a higher bit-depth or in a different color format from the video sequence produced using the base-layer bitstream alone.

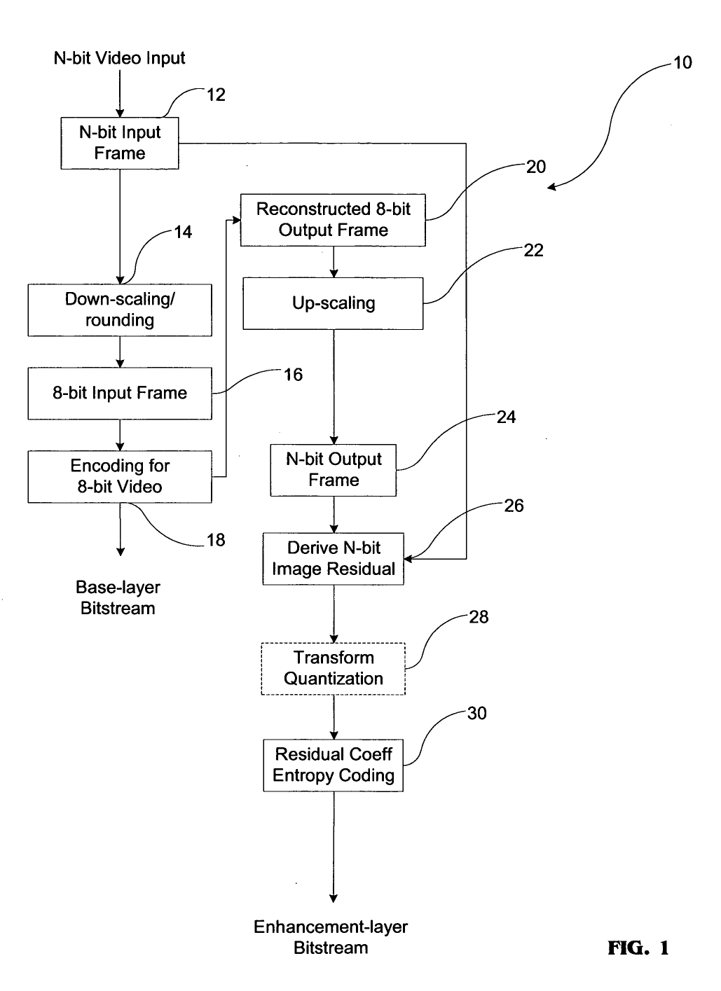

FIG. 1 illustrates a video coding sequence 10 according to an embodiment of the present method. An N-bit video input provides an N-bit input frame 12, where N is equal to or greater than eight (N≦8). Down-scaling/rounding is performed as shown at step 14 to produce an 8-bit input frame 16. In the case where N equals eight, the scaling factor will be one to produce an 8-bit input frame 16, for example where a format conversion is performed. An encoding process 18 is then used to produce a base-layer bitstream. The encoding process 18 may utilize any state-of-the-art process for encoding 8-bit video. In an embodiment of the present method, the base-layer bitstream may be decoded using existing 8-bit decoders. Step 20 reconstructs an 8-bit output frame from the base-layer bitstream encoded by the encoding process 18. Up-scaling is then performed on the 8-bit output frame, as shown at step 22, to produce an N-bit output frame 24. An N-bit image residual 26 is then derived by comparing the N-bit output frame 24 with the original N-bit input frame 12. In the case of a lossy encoding scheme, a transform and quantization step 28 is performed prior to entropy coding the residual coefficient at step 30, which produces an enhancement layer bitstream. In an alternative embodiment using a lossless encoding scheme the transform and quantization step 28 is eliminated.

The encoding process 18 may use any state-of-the-art 8-bit encoding process. Macroblocks within the base layer may be used to provide motion prediction for macroblocks within the enhancement layer.

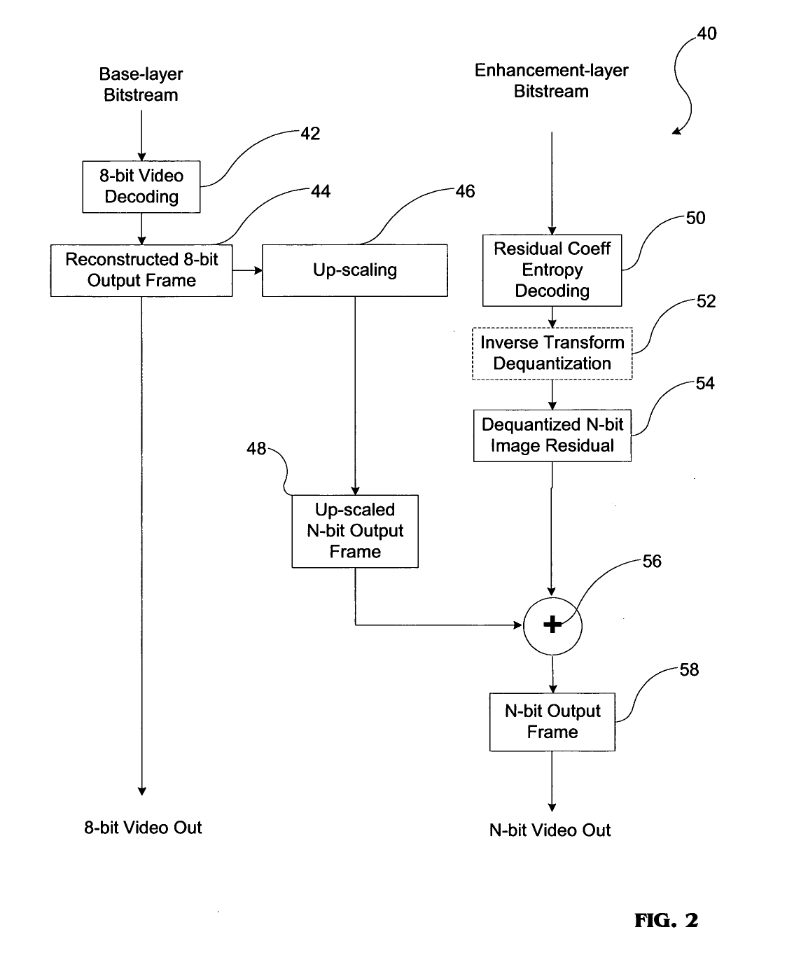

FIG. 2 illustrates a video decoding sequence 40 according to an embodiment of the present method. An 8-bit video decoding process 42 is performed on an incoming base-layer bitstream to produce a reconstructed 8-bit output frame 44, which provides an 8-bit video output. The reconstructed 8-bit output frame is also up-scaled, as shown at step 46, to produce an up-scaled N-bit output frame 48. In some embodiments, the up-scaling factor may be equal to one so as to produce an up-scaled 8-bit output frame. This is due to the factor N being equal to or greater than eight, in the limiting case of N equaling eight. In conjunction with the decoding of the base-layer bitstream, an enhancement-layer bitstream is also being decoded using residual coefficient entropy decoding as shown at step 50. Information required to determine the decoding process, for example the enhancement layer format, or bit-depth may be provided from the enhancement layer bitstream as supplemental enhancement information. In the case of the enhancement-layer bitstream having been encoded using a lossy encoding scheme, an inverse transform and dequantization step is performed as indicated by step 52 to produce an N-bit image residual 54. In an alternative embodiment in which the enhancement-layer bitstream was encoded using a lossless encoding scheme, the N-bit image residual 54 may be produced without the inverse transform and dequantization step 52. The N-bit image residual 54 is combined with the up-scaled N-bit output frame 48, as indicated at step 56, to produce an N-bit output frame 58 that will be used to provide an N-bit video output.

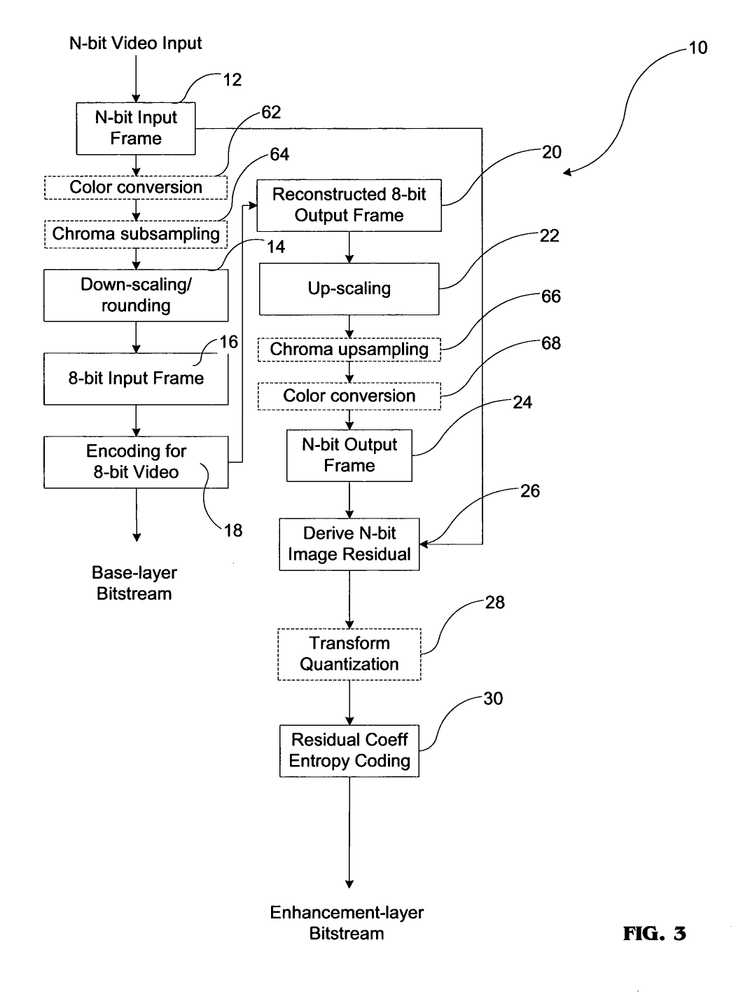

FIG. 3 illustrates a video coding sequence 10 according to an embodiment of the present method. The sequence is substantially similar to the sequence shown in FIG. 1. The process of converting an N-bit input frame 12 into an 8-bit input frame 16 now includes a color conversion step 62 and a chroma subsampling step 64. Either, or both, of these steps may be used during the process of converting an N-bit input frame 12 into an 8-bit input frame 16. The color conversion step 62 converts the N-bit input frame 12 from one color-space to another, for example converting RGB colors to YUV colors. Chroma subsampling may be used in connection with a color-space that contains luma and chroma components, allowing the chroma components to be coded using a lower resolution than that used for the luma component. The color conversion step 62 may be used to convert 4:4:4 RGB into 4:4:4 YUV. The chroma subsamping step 64 may then be used to convert the 4:4:4 YUV to 4:2:0 YUV. If the N-bit input frame 12 was already in a 4:4:4 YUV format it would be unnecessary to perform the color conversion step 62, for example. FIG. 3 shows one embodiment of the present method; in other embodiments the order of performing steps 62, 64 and 14 may be rearranged. Converting the reconstructed 8-bit output frame 20 to an N-bit output frame 24 may include a color conversion step 66 and a chroma upsampling step 68 to reverse the processes performed at steps 62 and 64.

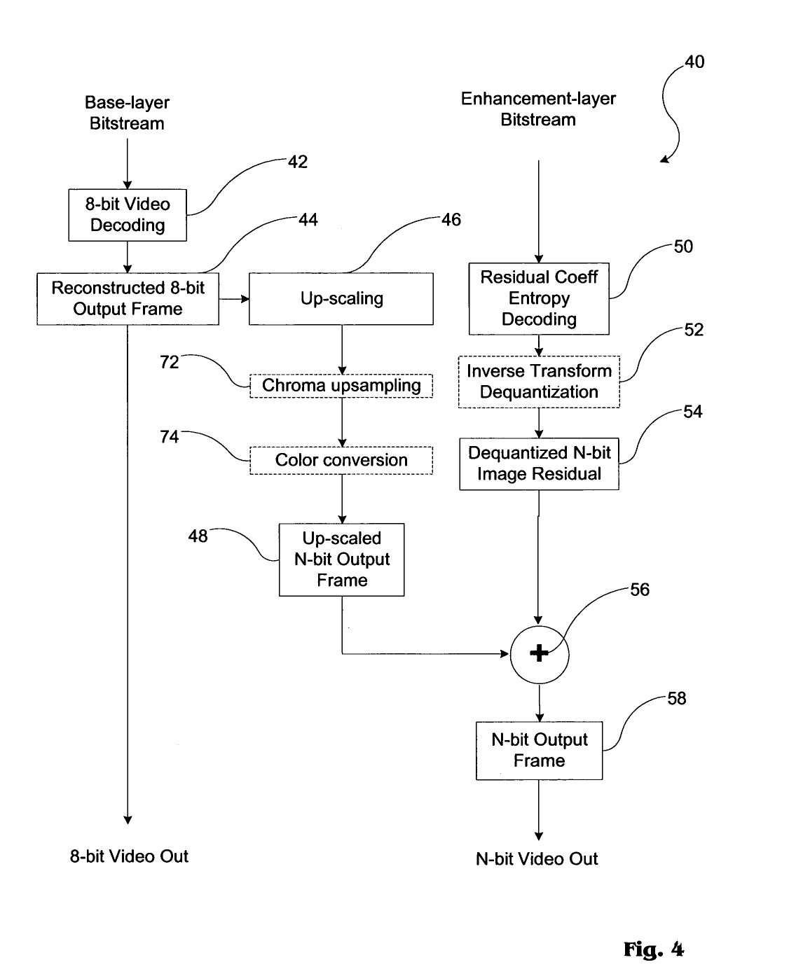

FIG. 4 illustrates a video decoding sequence 40 according to an embodiment of the present method for use in connection with the encoder shown in FIG. 3. An 8-bit video decoding process 42 is performed on an incoming base-layer bitstream to produce a reconstructed 8-bit output frame 44, which provides an 8-bit video output. The reconstructed 8-bit output frame is also up-scaled, as shown at step 46, to produce an up-scaled N-bit output frame 48. A color conversion step 72 and a chroma upsampling step 74 are shown along with the up-scaling step 46. FIG. 4 shows one embodiment of the present method; in other embodiments the order for steps 46, 72 and 74 may be rearranged as long as the process sequence remains compatible with the encoder so at to provide decoding. In some embodiments, the up-scaling factor may be equal to one so as to produce an up-scaled 8-bit output frame, which will account for situations in which there is color conversion or chroma upsampling without the need to up-scale the 8-bit output frame. In conjunction with the decoding of the base-layer bitstream, an enhancement-layer bitstream is also being decoded using residual coefficient entropy decoding as shown at step 50. In the case of the enhancement-layer bitstream having been encoded using a lossy encoding scheme, an inverse transform and dequantization step is performed as indicated by step 52 to produce an N-bit image residual 54. In an alternative embodiment in which the enhancement-layer bitstream was encoded using a lossless encoding scheme, the N-bit image residual 54 may be produced without the inverse transform and dequantization step 52. The N-bit image residual 54 is combined with the up-scaled N-bit output frame 48, as indicated at step 56, to produce an N-bit output frame 58 that will be used to provide an N-bit video output.

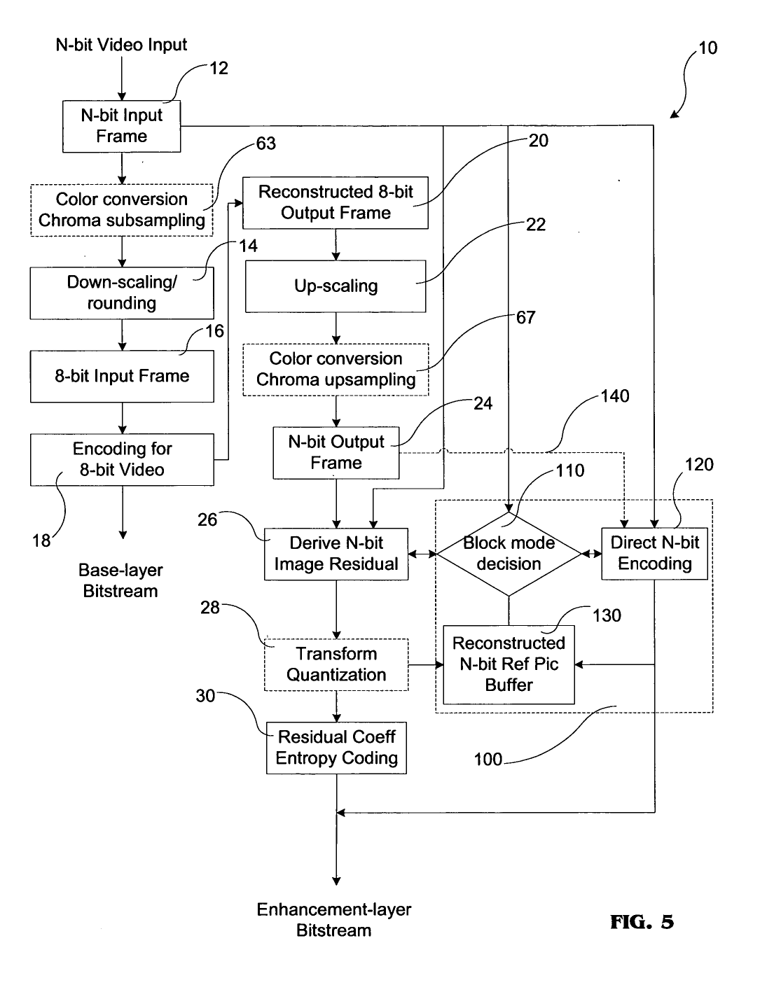

FIG. 5 illustrates a video coding sequence 10 according to an embodiment of the present method. The sequence is similar to the sequence shown in FIG. 3. The process of converting an N-bit input frame 12 into an 8-bit input frame 16 shows the optional steps of color conversion and chroma sub-sampling grouped together at step 63. These processes can each be performed separately, and in any suitable order, as discussed above. They are combined in the FIG. 5 for simplification of illustration only. Similarly, step 67 illustrates the processes of color conversion and chroma upsampling following reconstruction of the 8-bit output frame shown at step 20. The embodiment shown in FIG. 5 further includes a direct N-bit encoding process 100. A block mode decision 110 is made to determine whether to encode the enhancement layer using the image residual derived in step 26, or to encode the enhancement layer using a coding loop that encodes the N-bit data directly, as shown at block 120 (referred to as direct N-bit encoding). A reconstructed N-bit reference picture buffer 130 is used within the direct N-bit Encoding process 100 and may be reconstructed using transform/quanitization data taken from the image residual path or direct encoding data. A data path 140 from the N-bit output frame 24 to the direct N-bit encoding block is shown. This data path 140 is an alternative for providing data derived from the base layer to the direct N-bit encoding process 100. Alternatively, data based, at least in part, on the base layer is provided from block 26. The data path 140 may be provided in addition to the data path connecting block 26 to block 110.

The block mode decision 110 decides between using the N-bit image residual derived at step 26 or the direct N-bit encoding from step 120 to produce the enhancement layer bitstream. The block mode decision 110 is based upon optimizing coding efficiency. The block mode decision will then be signaled to enable the decoder to properly decode the enhancement layer bitstream. The block mode decision may be signaled in bitstream using any known method, for example using the Supplemental Enhancement Information (SEI) payload,

When the derived N-bit image residual is used to produce the enhancement layer bitstream, information within the base layer may used to provide motion prediction information for macroblocks within the enhancement layer.

When the direct N-bit encoding process 100 is used to produce the enhancement layer bitstream, information within the base layer or the enhancement layer may be used to provide motion prediction information for macroblocks within the enhancement layer.

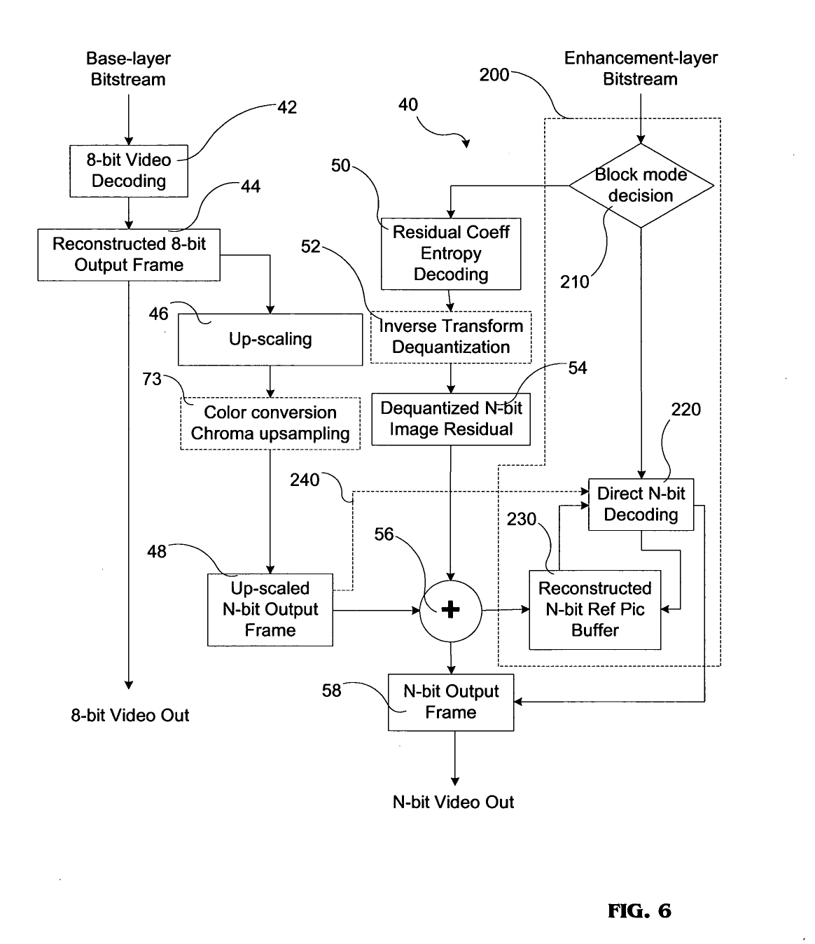

FIG. 6 illustrates a video decoding sequence 40 according to an embodiment of the present method for use in connection with the embodiment of the encoder shown in FIG. 5. The sequence is similar to the sequence shown in FIG. 4. An 8-bit video decoding process 42 is performed on an incoming base-layer bitstream to produce a reconstructed 8-bit output frame 44, which provides an 8-bit video output. The reconstructed 8-bit output frame is also up-scaled, as shown at step 46, to produce an up-scaled N-bit output frame 48. The process of producing the up-scaled N-bit output frame 48 shows the optional steps of color conversion and chroma upsampling grouped together as step 73. These processes can be performed separately, and in any suitable order. They are combined in the FIG. 6 for simplification of illustration only. The embodiment shown in FIG. 6 further includes a direct N-bit decoding process 200. A block mode decision 210 is made to signal whether to decode the enhancement layer using the residual coefficient entropy decoding step 50, or to decode the enhancement layer using a coding loop that decodes the N-bit data directly, as shown at block 220 (referred to as direct N-bit decoding). The block mode decision 210 may be signaled in a sequence level within the enhancement layer bitstream. The block mode can also be signaled for each macroblock within the enhancement layer. A reconstructed N-bit reference picture buffer 230 is used within the direct N-bit decoding process 200 and may be produced using the dequanitized N-bit image residual 54 taken from the image residual path combined with the up-scaled N-bit output frame 48 or using direct N-bit decoding information from step 220. A data path 240 from the up-scaled N-bit output frame 48 to the direct N-bit decoding block 220 is shown. This data path 240 is an alternative for providing data derived from the base layer to the direct N-bit decoding process 200. Alternatively, data based, at least in part, on the base layer is provided from block 56. The data path 240 may be provided in addition to the data path connecting block 56 to block 230.

When the residual coefficient entropy decoding 50 is used to produce the enhancement layer bitstream, macroblocks within the base layer may be used to provide motion prediction information for macroblocks within the enhancement layer.

When the direct N-bit decoding process 200 is used to produce the enhancement layer bitstream, macroblocks within the base layer or the enhancement layer may be used to provide motion prediction information for macroblocks within the enhancement layer.

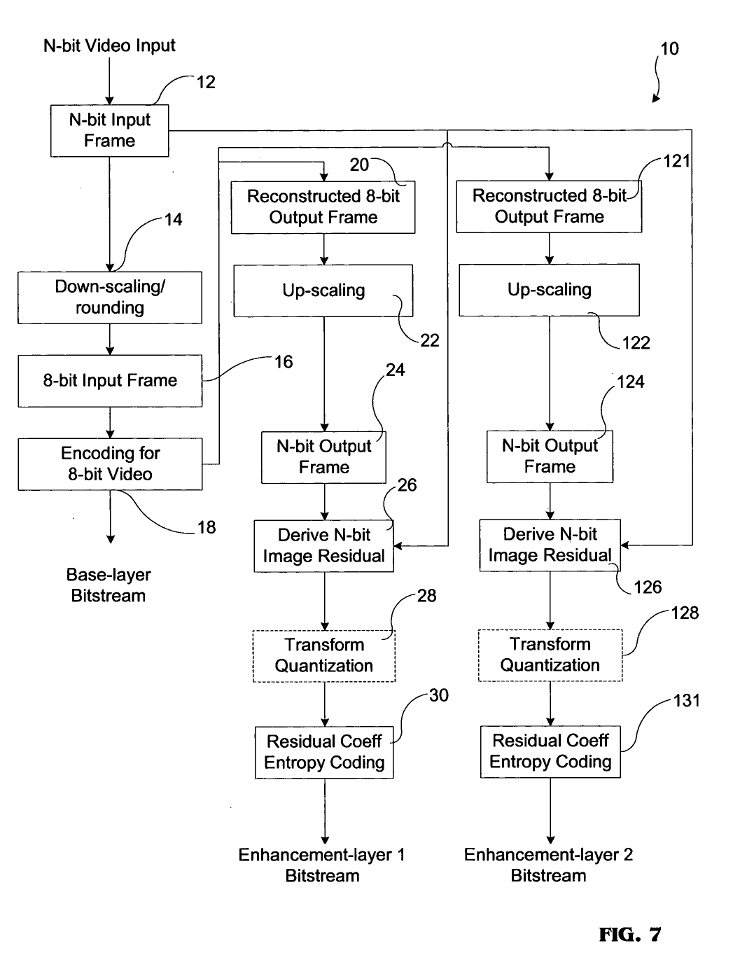

The quality-scalable process is not limited to only two layers. Based on the principle, a system may embed as many levels as it needs to handle different color formats and/or data bit depths. FIG. 7 illustrates an encoder capable of producing two separate enhancement layers. In this embodiment each enhancement layer may correspond to a different bit depth, or a different video format. A second encoding path is provided comprising a second reconstructed 8-bit output frame 121. In some embodiments the second encoding path may use the reconstructed 8-bit output frame 20. Up-scaling 122 is then performed to produce a second N-bit output frame 124. An N-bit image residual is derived at step 126 by comparing the N-bit output frame with the N-bit input frame. For the lossy case, an optional transform and quantizaton process 128 is performed followed by residual coefficient entropy coding to produce the enhancement-layer 2 bitstream. The basic coding path for each enhancement layer corresponds to the simpler example shown in FIG. 1. As would be understood by one of ordinary skill in the art, the encoding schemes shown in FIGS. 3 and 5 could also be repeated to produce two enhancement layers. Similarly, additional enhancement layer could be added as desired.

In operation, the new method provides professional video coding based on any existing 8-bit video coding systems, such as MPEG-2, MPEG-4, H.264, Windows Media, or Real Video. Since the residual coding/decoding process may be run in parallel to the regular 8-bit coding system, the additional cost of building such an N-bit video coding system may not be very significant. Additionally, a regular 8-bit decoder can be used to browse through the base-layer stream, which can be helpful for some professional applications.

As a possible setup for H.264, the base layer can be coded in 8-bit 4:2:0 YUV (or YCbCr, etc.) format which is a typical format for the Main profile; the enhancement layer can be coded as 10-bit 4:2:0, or 8-bit 4:2:2, or 10-bit 4:2:2, or 12-bit 4:4:4, which are all supported as profiles in the H.264 Fidelity Range Extension (FRExt). Of course, the base layer can also be coded in any of the FRExt profiles.

In terms of H.364, a new block mode could be added for the upper layer when the direct N-bit coding is activated to use the base-layer results as predictions. An alternative embodiment would redefine one of the existing modes, such as all the Intra DC modes, in the syntax and signal the option in the sequence level. A professional video system can be formed by combining a base-layer decoder and an upper-layer decoder or non-professional uses, a base-layer decoder shall be sufficient.

The proposed change to the syntax is very simple. An “external_mb_intra_dc_pred_flag” is added to the SPS to signal the scalable coding option. When the flag is on (1), MB-based Intra DC predictions, i.e., intra 16×16 DC mode (for luma) and intra chroma DC mode (chroma), will get prediction values from the collocated pixels in lower layer (temporally coincident) output picture instead of the neighboring pixels in the same picture. When the flag is off (0), the decoder should work as a single-layer decoder; no change is needed. The flag enables or disables the special prediction modes without any other syntax change. Lower layer information (such as resolution, color space, color format, bit depths, upsampling procedure, spec index, and other user data) can be summarized in a Supplemental Enhancement Information (SEI) payload. As understood by one of ordinary skill in the art, the lower layer information in the SEI message can be inserted for each picture, which means that the lower layer parameters can change frame by frame

The lower layer information (such as resolution, color space, color format, bit depths, upsampling procedure, spec index, and other user data) can also be summarized in a Supplemental Enhancement Information (SEI) payload as part of the upper layer bitstreams. Upsampling procedures should cover upsampling operations in both horizontal and vertical directions, and include simple replication, bilinear interpolation, and other user-defined filters, such as the 4-tap filters discussed in JVT-I019. The spec index could identify which decoder shall be used to decode the base layer, MPEG-2, or H.264 main, or other suitable format.

TABLE 1
Symbols

| lower_layer_video_info (payloadSize) { | C | Descriptor |
|---|---|---|
| spec_profile_idc | 5 | u(8) |
| pic_width_in_mbs_minus1 | 5 | ue(v) |
| pic_height_in_mbs_minus1 | 5 | ue(v) |
| chroma_format_idc | 5 | ue(v) |
| video_full_range_flag | 5 | u(1) |
| colour_primaries | 5 | u(8) |
| matrix_coefficients | 5 | u(8) |
| bit_depth_luma_minus8 | 5 | ue(v) |
| bit_depth_chroma_minus8 | 5 | ue(v) |
| luma_up_sampling_method | 5 | u(4) |
| chroma_up_sampling_method | 5 | u(4) |
| upsample_rect_left_offset | 5 | se(v) |
| upsample_rect_right_offset | 5 | se(v) |
| upsample_rect_top_offset | 5 | se(v) |
| upsample_rect_bottom_offset | 5 | se(v) |
| } | | |

The symbols upsample_rect_left_offset, upsample_rect_right_offset, upsample_rect_top_offset, and upsample_rect_bottom_offset, in units of one sample spacing relative to the luma sampling grid of the current (i.e., upper) layer bitstream, specify the relative position of the upsampled picture with respect to the picture in the current (i.e., upper) layer. In a typical case, when the resolutions are the same, all offset values should be 0.

The luma_up_sampling_method, chroma_up_sampling_method, upsample_rect_left_offset, upsample_rect_right_offset, upsample_rect_top_offset, and upsample_rect_bottom_offset may be provided for each picture, so that these values may be changed from frame to frame within the same video sequence.

The symbols spec_profile_idc, luma_up_sampling_method, and chroma_up_sampling_method are defined in the following tables. Definitions for all other symbols (pic_width_in_mbs_minus1, pic_height_in_mbs_minus1, chroma_format_idc, video_full_range_flag, colour_primaries, matrix_coefficients, bit_depth_luma_minus8, bit_depth_chroma_minus8) are similar to those defined in SPS and VUI sections. The only difference is that they are defined for the lower layer video in this SEI payload.

TABLE 2
Spec-Profile Index

| Value | Spec-Profile Index |
|---|---|
| 0 | H.264 main profile |
| 1 | MPEG-2 main profile |
| 2 | H.264 baseline profile |
| 3 | H.264 FRExt 4:2:0/10-bit |
| 4 | H.264 FRExt 4:2:2/8-bit |
| 5 | H.264 FRExt 4:2:2/10-bit |
| 6 | H.264 FRExt 4:4:4/12-bit |
| 7 | MPEG-4 simple profile |
| 8 | MPEG-4 advanced simple profile |
| 9 . . . 255 | reserved for future or other spec/profile (e.g., VC9, AVS, etc.) |

TABLE 3
Luma/Chroma Up Sampling Method

| Value | Up Sampling Method |
|---|---|
| 0 | None |
| 1 | simple replication or closest neighbour |
| 2 | bilinear interpolation |
| | (in spatial resolution of one-sixteenth luma sampling grid) |
| 3 . . . 15 | reserved for other method (e.g. JVT-I019, |
| | edge-adaptive filters, etc.) |

The method is independent from all popular scalable coding options, such as spatial scalability, temporal scalability, and conventional quality scalability (also known as SNR scalability). Therefore, the new quality-scalable coding method could theoretically be combined with any other existing scalable coding option.

The method has a fundamental difference from other existing scalable video coding systems, which require different layers from a same standard or specification. If we call the existing coding systems as ‘closed’ systems, our new method here can be considered as an ‘open’ system. This means that we can use different specifications for different layers. For example, as we mentioned earlier, we can use H.264 Fidelity Range Extension as upper layers, and MPEG-2, MPEG-4, or Windows Media, for example, as the lower layers.

In general, the concept of ‘open’ system can be used for scalable coding systems based, at least in part, on any video specification. An ‘open’ system supporting two layers should have two decoders running in parallel. Cases with more than two layers may require additional decoders. If the bitstream is a lower-layer bitstream, the lower-layer decoder should decode it and display it. If the bitstream is a self-contained upper-layer bitstream, the upper-layer decoder can handle it. If the bitstream is a scalable stream as indicted by a signal in the upper layer or system, the upper-layer decoder will decode the upper-layer bitstream using the outputs from the base layer that are stored and managed by a memory system.

The various embodiments may be implemented using encoder or decoders that are implemented as either software or hardware, as understood by those of ordinary skill in the art.

The above described embodiments, including any preferred embodiments, are solely for the purpose of illustration and do not define the scope of the invention. The scope of the invention shall be determined by reference to the following claims.

1. A decoder for quality scalable video comprising:
an 8-bit video decoder for decoding a base layer bitstream to produce a reconstructed 8-bit output frame; and
an N-bit video decoder adapted to produce an N-bit video output by combining an up-scaled N-bit output frame produced from a reconstructed 8-bit output frame with an N-bit image residual produced from an enhancement layer bitstream.

2. The decoder of claim 1, further comprising a direct N-bit decoder adapted to produce an N-bit output frame based upon the enhancement-layer bitstream.

3. The decoder of claim 2, wherein the direct N-bit decoder provides a block mode decision to signal direct N-bit decoding when indicated by the enhancement layer bitstream, and to signal N-bit image residual decoding when indicated by the enhancement layer bitstream.

4. The decoder of claim 3, wherein an H.264 block mode is provided within the direct N-bit decoder to use the base-layer results as predictions for the enhancement layer when signaled in a sequence level.

5. The decoder of claim 3, wherein an H.264 Intra DC mode is provided within the direct N-bit decoder to use the base-layer results as predictions for the enhancement layer bitstream when signaled in a sequence level.

6. A method of coding a quality scalable video sequence comprising:
providing a first N-bit input frame;
converting the first N-bit input frame to a first M-bit input frame, where M is an integer between 1 and N;
encoding the first M-bit input frame to produce a base-layer output bitstream;
reconstructing a first M-bit output frame from the base-layer output bitstream;
converting the first M-bit output frame to a first N-bit output frame;
comparing the first N-bit output frame to the first N-bit input frame to derive a first N-bit image residual; and
encoding the first N-bit image residual to produce an enhancement layer bitstream.

7. The method of claim 6, wherein M=8.

8. The method of claim 6, wherein converting the N-bit input frame to an M-bit input frame further comprises performing color conversion and converting the M-bit output frame to an N-bit output frame further comprises performing a reverse color conversion.

9. The method of claim 6, wherein converting the N-bit input frame to an M-bit input frame further comprises performing chroma subsampling and converting the M-bit output frame to an N-bit output frame further comprises performing chroma upsampling.

10. The method of claim 6, wherein encoding the N-bit image residual to produce an enhancement layer bitstream further comprises transforming and quantizing the N-bit image residual.

11. The method of claim 6, further comprising signaling lower layer coding parameters in the enhancement layer bitstream.

12. The method of claim 11, wherein the lower layer coding parameters comprise spec_profile_idc, pic_width_in_mbs_minus1, pic_height_in_mbs_minus1, chroma_format_idc, video_full_range_flag, colour_primaries, matrix_coefficients, bit_depth_luma_minus8, or bit_depth_chroma_minus8.

13. The method of claim 11, wherein the lower layer coding parameters comprise luma_up_sampling_method, chroma_up_sampling_method, upsample_rect_left_offset, upsample_rect_right_offset, upsample_rect_top_offset, or upsample_rect_bottom_offset.

14. The method of claim 13, further comprising signaling a first set of lower layer coding parameters for a first picture, and signaling a second set of lower layer coding parameters for a second picture.

15. The method of claim 6, further comprising:
providing a second N-bit input frame;
converting the second N-bit input frame to a second M-bit input frame, where M is an integer between 1 and N;
encoding the second M-bit input frame to produce the base-layer output bitstream;
encoding the N-bit input frame directly to produce the enhancement-layer bitstream.

16. The method of claim 15, further comprising producing a reconstructed N-bit reference picture buffer from the N-bit input frame.

17. A method of decoding a quality scalable video sequence comprising:
introducing a base-layer bitstream;
performing M-bit video decoding to provide a reconstructed M-bit output frame;
converting the M-bit output frame to an up-scaled N-bit output frame, where M is an integer between 1 and N;
introducing an enhancement layer bitstream;
decoding the enhancement layer bitstream to produce an N-bit image residual; and
combine the N-bit image residual with the up-scaled N-bit output frame to produce an N-bit output frame.

18. The method of claim 17, wherein M=8.

19. The method of claim 17, wherein converting the M-bit output frame to an up-scaled N-bit output frame further comprises performing color conversion.

20. The method of claim 17, wherein converting the M-bit output frame to an up-scaled N-bit output frame further comprises performing performing chroma subsampling.

21. The method of claim 17, wherein decoding the enhancement layer bitstream to produce an N-bit image residual further comprises performing an inverse transform and dequantization.

22. The method of claim 17, further comprising decoding at least a portion of the enhancement layer bitstream using direct N-bit decoding to provide a direct coded N-bit output frame.

23. The method of claim 22, further comprising producing a reconstructed N-bit reference picture buffer containing the direct coded N-bit output frame.
